(19) United States
(12) Patent Application Publication
(10) Pub. No.: US 2006/0000299 A1
(43) Pub. Date: Jan. 5, 2006

(54) Container inspection device moved by friction

(76) Inventors: Pascal Leroux, Treves (FR); Laurent Miranda De Azevedo, Lyon (FR); Dominique Pitaval, Saint Christo En Jarez (FR)

Correspondence Address: CLARK & BRODY, 1090 VERMONT AVENUE, NW, SUITE 250, WASHINGTON, DC, 20005, US

(21) Appl. No.: 11/165,191

(22) Filed: Jun. 24, 2005

(30) Foreign Application Priority Data
Jul. 2, 2004 (FR) 04 07 345

(51) Int. Cl. G01B 3/46; G01B 3/22; G01B 5/08

(52) U.S. Cl. 73/865.8; 33/522

(57) ABSTRACT

The invention concerns an inspection device for containers (2), that comprises a container inspection head (3) driven in alternate vertical movement via a driving member. According to the invention, the inspection head (3) has at least one driven rod (4) driven directly by friction in alternate vertical movement by the driving member (5).

The present invention pertains to the technical area concerned by the inspection of hollow items or containers in their general meaning, that are transparent or translucent such as glass bottles, jars, or flasks with a view to detecting any dimensional or surface defects of said container.

In the technical area of container inspection, especially glass containers, provision is made after their manufacture to conduct various inspections in particular of the neck ring of the container (inner/outer diameters, seal, height) and of the neck of the container (inner diameter, inner profile, bore).

In order to perform such inspections, it is known to use one or more devices each comprising an inspection head intended to be lowered either over a precise distance in relation to the type of container, or to be brought into contact with the container, or to be held against the inspection head during the inspection time. Conventionally, said inspection is conducted using a machine having either a linear conveyor adapted to hold the containers in precise positions, or a star conveyor having an indexed circular movement to position the containers in relation to different inspection stations. Each inspection head is moved with an alternating vertical movement for star conveyors while for a linear conveyor the inspection head additionally has a horizontal movement.

Patent FR 2 818 748 describes an inspection device comprising a head mounted on a horizontal slide which is fixed on a carriage that is moved in alternate vertical movements by a belt mounted between a loose pulley and a pulley driven by a servomotor. One of the disadvantages of said device is that the moving mass is relatively high which limits the movement speed and acceleration of the inspection head. It follows that the inspection rate of the containers is limited, which is a major drawback for the line production process of containers. Another disadvantage of said known device becomes apparent when the inspection head is intended to come into contact with the container. The stroke of the inspection head cannot be defined on account of the height dispersion of the containers and the defects which have an effect on this stroke, such as those not enabling the inspection head to be lowered for choked neck inspection. Therefore since this stroke is not determined, and having regard to the moving mass, a major impact may occur between the inspection head and the container, which may lead to deterioration of the container and/or inspection head.

The purpose of the present invention is to overcome the above disadvantages by proposing a device with which it is possible to conduct fast rate inspection especially of the neck ring and/or neck of the containers without risking any damage to the containers and/or inspection head.

To attain this objective, the subject of the invention concerns a container inspection device having a container inspection head that is driven in alternate vertical movement via a driving member.

According to the invention, the inspection head has at least one driven rod driven directly by friction by the driving member to increase the inspection rate of the containers.

Direct driving by friction via the driving member makes it possible to limit inertia and moving mass and to recover the driving force on the driven rod, without any allowance, which permits an increase in the dynamic capacities of the inspection head in terms of speed and acceleration in particular. Also, friction driving offers the advantage of allowing release by slippage in the event of mechanical conflict i.e. contact between the inspection head and the container.

To provide a solution to the phenomenon of wear generated by friction driving, in particular during slippage, the subject of the invention also proposes a preferred example of embodiment in which the driven rod is provided with a compensation-shock absorbing system inserted between the inspection head and the driven rod. Said compensation-shock absorbing system makes it possible to limit, even to cancel, slippage between the driving member and the driven rod when the inspection head comes into contact with the container, while limiting the impact between the inspection head and the container.

Advantageously, the compensation-shock absorbing system comprises a spring mounted in a body connected to the inspection head, the spring being acted upon by the driven rod.

Depending upon the type of inspection, the compensation-shock absorbing system advantageously comprises a detection sensor to detect relative movement between the driven rod and the inspection head in order to detect contact between the inspection head and the container.

Advantageously, the driving member consists of a wheel in friction on the driven rod, said wheel being driven in rotation by a motor member.

Preferably, the driven rod is maintained in frictional contact on the wheel by means of at least one presser roller.

A further purpose of the invention is to propose an inspection machine characterized in that it comprises at least one inspection device of the invention mounted on means for horizontal translation movement.

Various other characteristics will become apparent from the following description with reference to the appended drawings which, as non-limitative examples, describe embodiments of the subject of the invention.

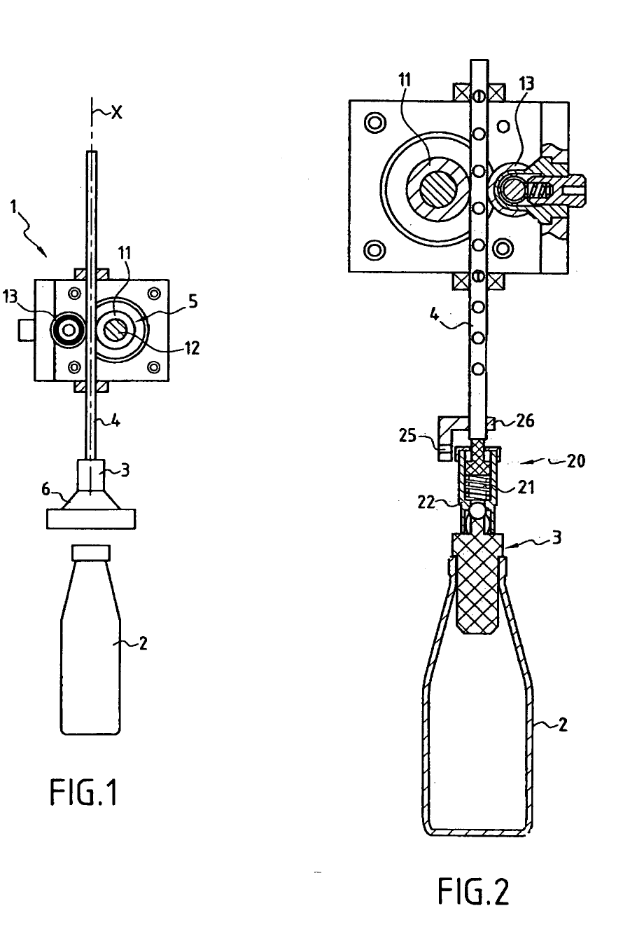

FIG. 1 is an elevation view of a first example of embodiment of a device according to the invention.

FIG. 2 illustrates a second variant of embodiment of an inspection device according to the invention.

In the example illustrated more particularly in FIG. 1, the subject of the invention concerns a device 1 adapted for the fast rate inspection of containers 2 of any kind such as glass containers for example, so as to conduct various inspections of the neck ring and/or neck of the container. Device 1 comprises an inspection head 3 adapted to the type of characteristics of the container to be inspected. In the example illustrated FIG. 1, the inspection head 3 is more particularly adapted to conduct inspection of the neck ring of the container 2. Each container 2 is successively brought into the alignment of the inspection head 3 by conveying means, not shown, of linear or rotating type.

Conventionally, the inspection head 3 forms a member driven in alternate vertical movement along a direction X so that it is firstly lowered to come into the vicinity of or in contact with the container, and is secondly moved away at the end of the inspection operation. The inspection head may be mounted on horizontal translation displacement means. The inspection head 3 is evidently part of an inspection station or machine, not shown but known as such. For this purpose, the inspection machine may be equipped with different inspection devices each adapted to the inspection to be carried out.

According to the invention, the inspection head 3 has at least one driven rod 4 directly driven by friction in an alternate vertical movement along direction X, by a driving member 5 so that slippage is possible between the driven rod 4 and the driving member 5. As follows from the example illustrated FIG. 1, the inspection head 3 is therefore in the form of a driven rod 4 provided, at its free end, with a body 6 integrating the various elements needed for inspecting the container. The direct driving of the driven rod 4 by the driving member 5 makes it possible to limit the moving mass, and hence to attain the necessary speed and acceleration values of the inspection head for fast inspection rates and even to optimise and differentiate the lowering and raising speeds of the inspection head 3 by reducing the lowering speed and increasing the raising speed. It therefore becomes possible, at a fast inspection rate, to limit the impact between the inspection head and the container, this impact being limited by the possibility of slippage offered by direct friction driving.

As can be seen FIG. 1, the driven rod 4 is friction driven directly by the driving member 5 driven in rotation. In the illustrated example, the driving member 5 consists of a wheel 11 in friction on the driven rod 4. This friction wheel 11 is driven in rotation by a motor member 12 of any known type. According to one preferred characteristic of embodiment, the driven rod 4 is maintained in contact with the wheel 11 using at least one presser roller 13 preferably positioned opposite wheel 11. The use of a mobile rod 4 on which a friction wheel 11 can act makes it possible to reduce the moved mass. This said solution offers the additional advantage of having a driven rod 4 whose design is independent of the driving member 5.

According to a variant of embodiment, the presser roller 13 is pressure-adjustably mounted on the driven rod 4 so that it is possible to adjust the contact pressure of wheel 11 on the driven rod 4 and subsequently to compensate for the phenomenon of wear through this friction driving.

According to one advantageous characteristic of embodiment, the driven rod 4 is equipped with a wear piece, preferably of removable type, on which the driving member 5 acts directly by friction. The driven rod 4 can therefore be made in a different material to the constituent material of the wear piece in contact with the wheel 11. Therefore the driven rod 4 may be made in a light material, such as aluminium, plastic or composite material, while the wear piece is made in a material adapted for friction driving, such as hardened steel for example. This variant of embodiment enables the weight of the driven rod 4 to be reduced, while limiting maintenance to replacement of the wear piece.

FIG. 2 illustrates a variant of embodiment in which the driven rod 4 is equipped with a compensation-shock absorbing system 20 located between the inspection head 3 and the driven rod 4. It is to be noted that according to this example, the inspection head 3 is more particularly adapted to conduct choked neck inspection, but it is evident that said shock absorbing system may be used with any type of inspection head 3, for example for neck ring inspection.

In the illustrated preferred example of embodiment, the compensation-shock absorbing system 20 comprises a spring 21 mounted in a body 22 connected to the inspection head 3. Compression forces are applied against spring 21 by the driven rod 4. Evidently, provision may be made to use a compensation-shock absorbing system 20 different to a spring, such as a gas system.

It is to be considered that the compensation-shock absorbing system 20 is an elastically deformable system allowing the driven rod 4 to perform its effective stroke, irrespective of the contact position between the container and the inspection head, while avoiding the phenomenon of slippage and hence of wear of the friction drive. With said system 20 it is therefore possible to compensate for the stroke of the driven rod 4 while avoiding slippage. Also, the compensation-shock absorbing system 20 makes it possible to dampen the impact between the inspection head and the container by absorbing the energy of the driven rod 4.

According to a preferred embodiment, the compensation-shock absorbing system 20 comprises a detection sensor 25 adapted to detect contact between the inspection head 3 and the container 2. For example, sensor 25, which may be of any type, is mounted on a support 26 fixed to the driven rod 4, so as to detect the relative movement between the inspection head 3 and the driven rod 4. The sensor 25 is therefore able to give the motor member 12 a stop command for the descending stroke of the inspection head 3. It therefore appears possible to compensate the stroke of the driven rod 4 which is reduced to the stroke required for its stoppage. This contact detection is particularly advantageous when the compensation of the stroke of the inspection head 3 has a high value (for example in the order of 120 mm) to take into account any defects when conducting an inspection of choked neck type. During this type of inspection, the inspection head 3 may be stopped in its descending stroke on account of a defect, at a distance of the order of 120 mm, with respect to the desired inspecting position. This gives rise to a reduction in mass of system 20 thereby making it possible to increase the dynamic capacities of the inspection head.

The functioning of the compensation-shock absorbing system 20 follows directly from the preceding description. When the inspection head 3 is in contact or bears against the container 2, the continued lowering of the driven rod 4 leads to compression of spring 21 and to relative movement between the body 22 and the driven rod 4. Said relative movement is detected by the sensor 25. For example, the sensor 25 commands the motor member 12, immediately or after a given time interval, to move in the opposite direction of motion, i.e. a raising movement.

It is to be understood that with the compensation-shock absorbing system 20 it is possible to avoid slippage between the driven rod 4 and the friction wheel 11 when the inspection head 3 contacts the container 2, which reduces wear of the friction drive. Also, the compensation-shock absorbing system 20 limits the impact at the time of contact between the inspection head 3 and the container 2. In addition, the spring 21 contributes towards braking and to the re-acceleration of the driven rod 4 when its direction of movement is reversed.

The invention is not limited to the examples described and illustrated, as various modifications may be made thereto without departing from the scope of the invention.

1. Container inspection device, comprising a container inspection head driven in alternate vertical movement via a driving member, characterized in that the inspection head has at least one driven rod driven directly by friction by the driving member to increase the inspection rate of the containers.

2. Inspection device as in claim 1, characterized in that the driven rod is equipped with a compensation-shock absorbing system inserted between the inspection head and the driven rod.

3. Inspection device as in claim 2, characterized in that the compensation-shock absorbing system comprises a spring mounted in a body connected to the inspection head, the spring undergoing action by the driven rod.

4. Inspection device as in claim 2, characterized in that the compensation-shock absorbing system comprises a detection sensor of the relative movement between the driven rod and the inspection head in order to detect contact between the inspection head and the container.

5. Inspection device as in claim 1, characterized in that the driving member consists of a wheel in friction on the driven rod, said wheel being driven in rotation by a motor member.

6. Inspection device as in claim 5, characterized in that the driven rod is maintained in contact by friction on the wheel by means of at least one presser roller.

7. Inspection device as in claim 6, characterized in that the presser roller is pressure-adjustably mounted on the driven rod.

8. Inspection device as in claim 1, characterized in that the driven rod is equipped with a removable wear piece on which the driving member acts directly by friction.

9. Inspection machine characterized in that it comprises at least one inspection device as in claim 1, mounted on horizontal translation displacement means.

10. Inspection device as in claim 3, characterized in that the compensation-shock absorbing system comprises a detection sensor of the relative movement between the driven rod and the inspection head in order to detect contact between the inspection head and the container.

11. Inspection device as in claim 5, characterized in that the driven rod is equipped with a removable wear piece on which the driving member acts directly by friction.

12. Inspection machine characterized in that it comprises at least one inspection device as in claim 2, mounted on horizontal translation displacement means.

13. Inspection machine characterized in that it comprises at least one inspection device as in claim 3, mounted on horizontal translation displacement means.

14. Inspection machine characterized in that it comprises at least one inspection device as in claim 4, mounted on horizontal translation displacement means.

15. Inspection machine characterized in that it comprises at least one inspection device as in claim 5, mounted on horizontal translation displacement means.

16. Inspection machine characterized in that it comprises at least one inspection device as in claim 6, mounted on horizontal translation displacement means.

17. Inspection machine characterized in that it comprises at least one inspection device as in claim 7, mounted on horizontal translation displacement means.

18. Inspection machine characterized in that it comprises at least one inspection device as in claim 8, mounted on horizontal translation displacement means.
